(19) United States
(12) Patent Application Publication
(10) Pub. No.: US 2014/0354008 A1
(43) Pub. Date: Dec. 4, 2014

(54) VEHICLE BODY FRONT PORTION STRUCTURE

(71) Applicant: Toyota Jidosha Kabushiki Kaisha, Toyota-shi Aichi-ken (JP)

(72) Inventors: Kosuke Sakakibara, Toyota-shi Aichi-ken (JP); Tomoyuki Kuriyama, Toyota-shi Aichi-ken (JP); Masanobu Omi, Kasugai-shi Aichi-ken (JP); Akihiro Tamaoki, Tajimi-shi Gifu-ken (JP)

(73) Assignee: Toyota Jidosha Kabushiki Kaisha, Toyota-shi Aichi-ken (JP)

(21) Appl. No.: 14/282,422

(22) Filed: May 20, 2014

(30) Foreign Application Priority Data
Jun. 3, 2013 (JP) 2013-117222

(51) Int. Cl. B62D 25/08; B60R 19/02

(52) U.S. Cl. CPC B62D 25/082; B60R 19/023
USPC 296/187.1

(57) ABSTRACT

A vehicle body front portion structure includes a front side member arranged such that its lengthwise direction coincides with a vehicle front-rearward direction, the front side member being arranged to offset to a vehicle width directional one side; a bumper reinforcement arranged such that its lengthwise direction coincides with the vehicle-width direction and arranged in front of the front side member in the vehicle front-rearward direction such that one side end portion of the bumper reinforcement in the vehicle-width direction extends outwardly in the vehicle width-direction from the front side member; and a crash box interposed between a front end portion of the front side member and the bumper reinforcement and configured such that a vehicle-width directional outer side of the crash box is lower in strength against a load from a frontward direction of the vehicle than a vehicle width directional inner side of the crash box.

### INCORPORATION BY REFERENCE

The disclosure of Japanese Patent Application No. 2013-117222 filed on Jun. 3, 2013 including the specification, drawings and abstract is incorporated herein by reference in its entirety.

### BACKGROUND OF THE INVENTION

1. Field of the Invention

The present invention relates to a vehicle body front portion structure.

2. Description of Related Art

A structure has been known that includes a second protrusion provided at a rear side of an extension part of a bumper beam and a first protrusion extending outside in a vehicle width direction from a side frame, in which, upon collision with a pole extension part of a bumper beam, the first protrusion and the second protrusion are brought into interference with each other (See Japanese Patent Application Publication No. 2012-228907 (JP 2012-228907 A), for example).

Incidentally, in the aforementioned structure, two protrusions are required and therefore employing the structure concerned will cause the number of parts and the mass to increase.

### SUMMARY OF THE INVENTION

An object of the present invention is to provide a vehicle body front portion structure which is capable of improving collision performance against a collision mode in which an overlap amount of a collision body is short relative to a bumper reinforcement, with the number of parts and the increase of mass suppressed.

A vehicle body front portion according to an embodiment of the present invention includes: a front side member arranged such that lengthwise direction of the front side member is in coincidence with a vehicle front-rearward direction, the front side member being arranged to offset to a vehicle width directional one side; a bumper reinforcement arranged such that lengthwise direction of the bumper reinforcement in coincidence with the vehicle width direction, the bumper reinforcement being arranged in front of the front side member in the vehicle front-rearward direction such that an one side end portion of the bumper reinforcement in the vehicle width direction extends outwardly in the vehicle width direction relative to the front side member; and an energy absorbing member interposed between a front end portion of the front side member and the bumper reinforcement, the energy absorbing member being configured such that a vehicle width directional outer side of the energy absorbing member is lower in strength against a load from a frontward direction of the vehicle than a vehicle width directional inner side of the energy absorbing member.

In this vehicle body front portion structure, for example, when a vehicle width directional one side of the bumper reinforcement is in receipt of a collision load, the energy absorbing member is deformed, thereby energy absorption is achieved. This energy absorbing member is deformed, at least upon initial stage of the collision, largely at its vehicle width directional outer side than its vehicle width directional inner side. Thereby, the bumper reinforcement is promoted to bend its vehicle width directional outer end portion of the bumper reinforcement in the rearward direction. And when the resulting vehicle width directional outer end portion of the bumper reinforcement is brought into engagement with the front side member from the outside in the vehicle width direction, the resulting front side member is brought into bending (folding) deformation in the vehicle width direction. These deformations of the bumper reinforcement and the front side member also serve for absorbing the collision energy.

Thus, in the aforementioned vehicle body front portion structure is capable of improving collision performance against a collision mode in which an overlap amount of a collision body is short relative to bumper reinforcement, with the number of parts and the increase of mass suppressed, when compared to the structure having plural protrusions.

In the vehicle body front portion structure, a low strength portion which is set to be lower in strength against bending than other portions may be formed at a specific portion of a wall portion of the front side member in the vehicle front-rearward direction that faces outwardly in the vehicle width direction.

In this vehicle body front portion structure, the bending (folding) deformation of the front side member, which begins from the low strength portion, is promoted, allowing for contribution to highly efficient energy absorption.

In this vehicle body front portion structure, the low strength portion may be in the form of a concave bead which opens toward outwardly in the vehicle width direction at the wall portion, the concave bead being arranged such that lengthwise direction of the concave bead is in coincidence with a vehicle vertical direction.

In this vehicle body front portion structure, the concave bead, which is elongated in the vertical direction, opens toward outwardly in the vehicle width direction, thereby promoting further the bending (folding) deformation of the front side member, allowing for further contribution to highly efficient energy absorption.

In the vehicle body front portion structure, a portion of the bumper reinforcement which projects outwardly in the vehicle width direction from the front side member may be formed with a projection which extends in a vehicle rearward direction.

In this vehicle body front portion structure, when the vehicle width directional outer end portion of the bumper reinforcement is bent rearwardly, the projection is brought into engagement with the front side member from the outside in the vehicle width direction. The projection concentrates the load from the collision member on the specific portion of the front side member, which promotes the bending (folding) deformation of the front side member, resulting in contribution of highly efficient energy absorption.

In the vehicle body front portion structure, a low strength portion may be formed at a specific portion of a wall portion of the front side member in the vehicle front-rearward direction that faces outwardly in the vehicle width direction, the low strength portion being set to be lower in strength against bending than other portions. Also, the low strength portion in the wall portion is formed at a position where a length between a front end portion of a vehicle width direction inside part of the energy absorbing member and the low strength portion is equal to a length between the front end portion of a vehicle width direction inside part of the energy absorbing member and the projection.

In this vehicle body front portion structure, when the vehicle width directional outer end portion side of the bumper reinforcement is bent rearwardly, the projection is brought into engagement with the low strength portion of the front side member from the outside in the vehicle width direction. The projection concentrates the load from the collision member on the low strength portion of the front side member, thereby promoting further the bending (folding) deformation of the front side member, allowing for further contribution to highly efficient energy absorption.

As described above, the vehicle body front portion structure according to one embodiment of the present invention is capable of providing excellent effects of improving collision performance against a collision mode in which an overlap amount of a collision body is short relative to the bumper reinforcement, with the number of parts and the increase of mass suppressed.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a principal part of a vehicle body front portion structure according to one embodiment of the present invention;

FIG. 2 is a perspective view of a deformation mode, upon short overlap collision, the vehicle body front portion structure according to one embodiment of the present invention;

FIG. 3A is a view of a principal part of the vehicle body front portion structure according to one embodiment of the present invention to illustrate the same in a plane which is before the deformation due to the short overlap collision; and

FIG. 3B is a view of a principal part of the vehicle body front portion structure according to one embodiment of the present invention to illustrate the same in a plane which is in the deformation mode after the short overlap collision.

### DETAILED DESCRIPTION OF EMBODIMENTS

A vehicle body front portion structure 10 according to one embodiment of the present invention will be described with reference to the attached drawings. It is to be noted that arrows FR, UP, and LH, which are appropriately appear in each Figure, indicates a frontward direction, an upward direction, and a leftward direction, respectively, of a vehicle to which the vehicle body front portion structure 10 is applied. In the following explanation, when front-rearward direction, vertical direction, and left and right direction are used in abridged fashion, it should be understood, unless otherwise specifically noted, that they indicate the front and rear in the front-rearward direction, the up and down in the vehicle vertical direction, and the right and left in the vehicle right and left direction when looking at the frontward of the vehicle, respectively. The vehicle body front portion structure 10 is basically a right and left symmetrical structure with respect to a center line in the vehicle width direction and therefore hereinafter the explanation focuses on the part of left side i.e., in the vehicle width directional one side.

[Schematic Configuration of Vehicle Front Portion Structure]

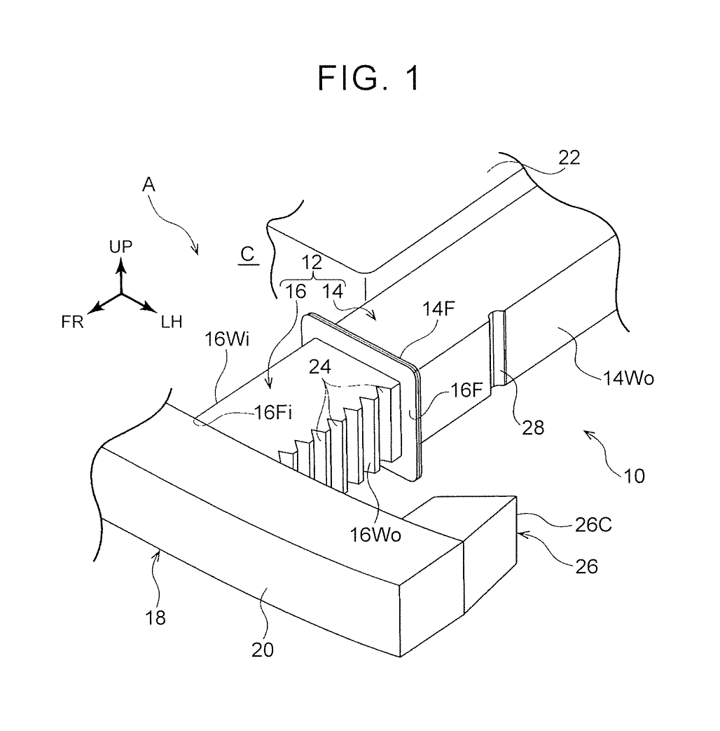

In FIG. 1, the vehicle body front portion structure 10 is schematically illustrated in perspective. As shown in this Figure, vehicle body front portion structure 10 includes a pair of framing members 12 (only the left side framing member is shown in each Figure), whose lengthwise directions are in coincidence with the front-rearward direction, are arranged in parallel relationship in the vehicle width direction. The framing member 12 is configured to includes, as its main portions, a front side member 14 and a crash box 16 provided at a front end portion of the front side member 14. A rear portion of the front side member 14 extends under a dash panel (not shown) and terminates in an under side of a cabin floor.

The front side member 14 forms a closed section structure (not shown) in cross-sectional view perpendicular to the lengthwise (front-rearward) direction. Similarly, the crash box 16 also forms a closed section structure (not shown) in cross-sectional view perpendicular to the lengthwise (front-rearward) direction. Each of the crash boxes 16 is combined, at its flange 16F formed at its rear end portion, with the corresponding flange 14F that is formed at a front end portion of the front side member 14 by means of bolt and nut connection (not shown).

And, each the crash box 16 is configured to be easier in compressive (collapse) deformation against a front-rearward directional load than the front side member 14. Consequently, when each of the framing members 12 comes to be in receipt of a load from a bumper reinforcement 18 which will be described later, at first, the crash box 16 will be in compressive deformation. That is to say, the crash box 16 in this embodiment acts as an energy absorbing portion. Regarding the crash box 16, its detailed construction and compressive (collapse) characteristic will be described later.

A bumper reinforcement 18 as a bumper framing portion bridges between front end portions of both the crash boxes 16. The bumper reinforcement 18 is in the form of framing element whose lengthwise direction is in coincidence with the vehicle width direction and forms a closed section structure in cross-sectional view perpendicular to the lengthwise direction. Lengthwise directional opposite end portions of the bumper reinforcement 18 are in the form of extending portions 20 that extend outwardly in the vehicle width direction relative to the respective framing members 12.

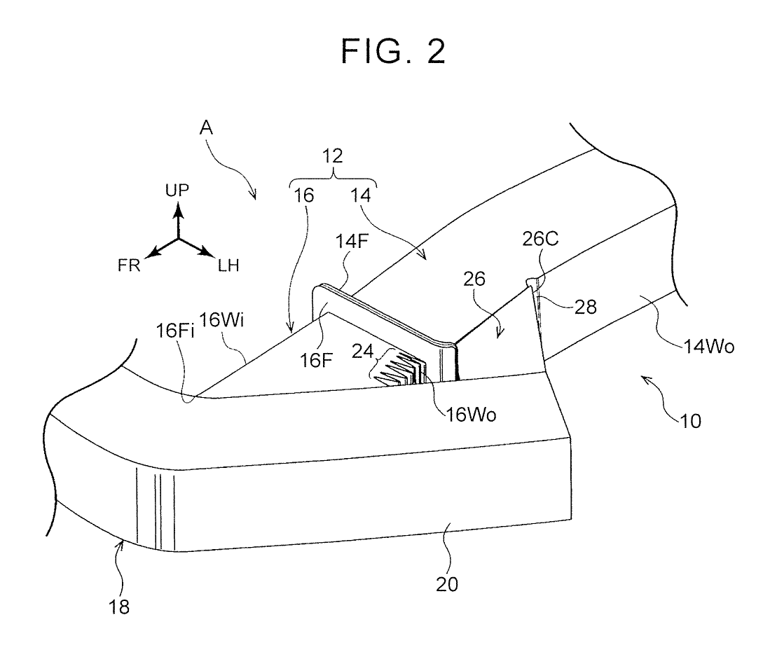

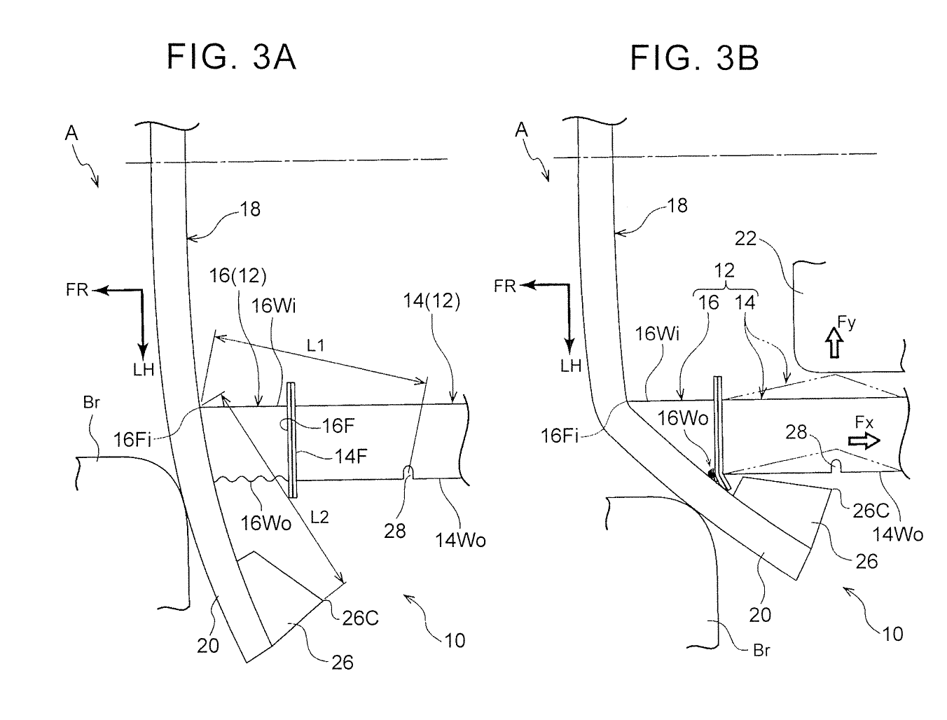

In addition, in the vehicle body front portion structure 10, a power unit 22 is arranged between the right and left positioned front side members 14 within an engine compartment C. In this embodiment, the power unit 22 is connected to (supported by) the front side members 14 via a mounting member, suspension member, and other member (not shown). It is to be noted that the power unit 22 is omitted to illustrate in FIG. 2 and FIG. 3A.

[Crash Box]

As can be understood from the aforementioned description, the crash box 16 is interposed between the bumper reinforcement 18 and the front end portion of the front side member 14. And, in the present embodiment, the crash box 16 is configured such that outer side portion of the crash box 16 in the vehicle width direction is lower in strength (easier to deform) against a load from the vehicle front direction (compression load) than inner side portion of the crash box 16 in the vehicle width direction. A detailed description will be made hereinafter.

As described above, a plurality of parallel spaced apart vertical beads 24 which are arranged in the front-rearward direction and which are in the form of easy to deform structures, respectively, are formed in an outer side wall 16Wo which is a vehicle width directional outer side wall portion of the crash box 16 which forms the closed section structure. Each of the vertical beads 24 constitutes a groove which extends from a lowermost end of the outer side wall 16Wo to an uppermost end thereof and which opens outwardly in the vehicle width direction on the outer side wall 16Wo. In other words, the outer side wall 16Wo provides a corrugated plate shape whose plane cross-section looks like a wave whose amplitude direction is in coincidence with the vehicle width direction.

Thereby, the outer side wall 16Wo is capable of being brought into a compression deformation by a low load in such a manner that when the outer side wall 16Wo is in receipt of a compression load, plural portions of the outer side wall 16Wo are bent while the pitch between two adjacent vertical beads 24 is being decreased. On the other hand, an inner side wall 16Wi, which is a vehicle width directional inside wall portion of the crash box 16, is in the form of a plate shape and otherwise a plate on which a small bead for the load adjustment and is capable of being deformed or broken by mainly buckling upon receipt of a compression load. Thereby, as described above, against the load from the frontward direction of the vehicle (the compression load), the crash box 16 is configured such that its vehicle width directional outer portion is lower in strength than its vehicle width directional inner portion.

In the aforementioned crash box 16, when the extending portion 20 is in receipt of the compression load, mainly the outer side wall 16Wo is brought into compression deformation (breakage), thereby absorbing some of the resulting collision energy.

In addition, the crash box 16 is configured in such a manner that against the compression load inputted to the bumper reinforcement 18, the outer side wall 16Wo is faster in progression of compression breakage than the inner side wall 16Wi as long as the crash box 16 is in overlap with the inputted load in front view. In other words, against such a load, the configuration provides an antecedent compression breakage of the outer side wall 16Wo relative to the inner side wall 16Wi. It is to be noted that in such a case, the collision body against the bumper reinforcement 18 moves in the rearward direction relative to the vehicle body, while changing its posture slightly in accordance with the antecedent compression breakage of the outer side wall 16Wo relative to the inner side wall 16Wi.

Further, in the crash box 16, against a compression load inputted to a vehicle width directional center portion of the bumper reinforcement, both the outer side wall 16Wo and the inner side wall 16Wi are brought into compression deformations (breakages), respectively, almost simultaneously and absorb some of the collision energy and absorb.

[Spacer Member]

The vehicle body front portion structure 10 having the aforementioned basic configuration includes a spacer member 26 as a protrusion. The spacer member 26 is arranged to occupy a space between a rearward surface of the extending portion 20 of the bumper reinforcement 18 and the vehicle width directional outer surface of the framing member 12. In this embodiment, the spacer member 26 is formed as a protrusion which project from a vehicle width directional outer end portion of the extending portion 20 toward the outer side wall 14Wo of the front side member 14.

In this embodiment, the spacer member 26 is in the form of a trapezoidal or sector shape, when viewed in plain, whose width along the front-rearward direction (a width direction of the bumper reinforcement 18) becomes larger in the vehicle width directional outer side than in the vehicle width directional inner side. Thereby, a corner portion 26C, which is at the vehicle width directional outer end portion of the spacer member 26 and is concurrently at a rear end portion of the spacer member 26, is in a rearmost position of the spacer member 26.

Such a spacer member 26 is configured to be brought into contact (interference) with the outer side wall 14Wo of the front side member 14 when the extending portion 20 is displaced in the rearward direction and concurrently inwardly in the vehicle width direction by a load applied to the vehicle rearward direction from a barrier Br (See FIG. 3) that is an example of the collision body. Thereby, the spacer member 26 functions as a load transmission member which converts the rearward directional load inputted from the barrier Br to the extending portion 20 into a load involving a vehicle width directional inward component and transmitting the resulting load to in the vicinity of the front end portion of the front side member 14.

In the following description, sometimes the vehicle width directional inward load converted by the spacer member 26 may be referred as to “lateral force”. And, in this embodiment, the spacer member 26 is configured to be of higher strength (load resistance) than the bending strength of the front side member 14. For this reason, without appreciable deforming, the spacer member 26, the lateral force deforms the front side member 14, resulting in that the lateral force is transmitted to the power unit 22.

[Low Strength Portion]

In addition, in the front side member 14 which constitutes the vehicle body front portion structure 10, a low strength portion (weak body portion) 28 is formed which is lower in strength against the bending load in the vehicle width direction than other portions. In this embodiment, the low strength portion 28 is formed as a concave bead which is formed in the outer side wall 14Wo of the front side member 14 to open outwardly in the vehicle width direction.

In addition, the front side member 14 in which the low strength portion 28 is formed is secured with a load resistance, which is requested for load transmission (support) upon full lap front collision, against the compression in the axial direction.

Such a low strength portion 28 is so arranged as to equalize a length measured from the front end portion of the crash box 16 to the low strength portion 28 and a length between the front end portion of the crash box 16 and a tip end of the spacer member 26. More specifically, as illustrated in FIG. 3A, a length L1 between a front end portion 16Fi of the inner side wall 16Wi of the crash box 16 and the low strength portion 28 is equal to a length L2 between the front end portion 16Fi of the inner side wall 16Wi of the crash box 16 and the corner portion 26C of the spacer member 26.

[Operation]

Next, an operation of a first embodiment will be described.

(Short Overlap Collision or Oblique Collision)

First of all, an operation will be described in a case where the automotive vehicle A to which the vehicle body front portion structure 10 is brought into a mode of collision in which collision body collides at mainly the left side or the vehicle width directional one side of the automotive vehicle A. Examples of such a mode include short overlap collision and oblique collision.

Here, the short overlap collision is defined as a kind of front end collision in which the automotive vehicle A collides with, for example, an IIHS defined opponent collision body with an overlap amount of 25% or less in the vehicle width direction. For example, a collision with the vehicle width directional outer portion of the front side member as the framing member corresponds to the short overlap collision. In this embodiment, as an example, the short overlap collision is assumed at a relative speed of 64 km/hr. In addition, the oblique collision means, for example, the diagonal front collision defined by NHTSA (one example: the relative angle with respect to the collision body is 15° and the overlap amount in the vehicle width direction is about 35%). In this embodiment, as an example, the diagonal front collision at a relative speed of 90 km/hr is assumed.

In a case where such a mode (short overlap collision as exemplified in FIG. 3A) occurs, a rearward directed load is inputted from the barrier Br to the vehicle width directional end portion of the bumper reinforcement 18 (the extending portion 20 or the lapped portion, in front view, with the crash box 16). Then, as illustrated in FIG. 2 and FIG. 3B, the crash box 16 is, as illustrated in FIG. 2 and FIG. 3B, at least in an initial stage of the collision, the outer side wall 16Wo is brought into compression breakage which is larger than the compression breakage of the inner side wall 16Wi, thereby fulfilling the energy absorption in the initial stage of the collision. In particular, the outer side wall 16Wo is in the form of the corrugated plate in which the plural vertical beads 24 are provided, which makes it possible to generate the deformation characteristic of the crash box 16 with higher accuracy in which the outer side wall 16Wo is to be larger in compression breakage (to improve robustness) than the inner side wall 16Wi.

And, after the compression breakage of the outer side wall 16Wo of the crash box 16 which is larger than that of the inner side wall 16Wi, the vehicle width directional end portion of the bumper reinforcement 18 (the extending portion 20 and the portion connected to the crash box 16), in front view, is brought into large inclination toward the rearward direction. That is to say, bumper reinforcement 18 comes to be bent (folded) from the front end portion of the inner side wall 16Wi of the crash box 16.

Subsequent to the bending (folding) of the bumper reinforcement 18, the spacer member 26 provided at the vehicle width directional outer end portion of the bumper reinforcement 18 comes to contact and interfere with the outer side wall 14Wo of the front side member 14. As depicted by the imaginary line in FIG. 3B, the load is transmitted as the lateral force from the barrier Br, via the spacer member 26, to the front side member 14, which causes the front side member 14 to bend (fold).

Especially, in the present embodiment, the length L1 between the front end portion 16Fi of the inner side wall 16Wi of the crash box 16 and the low strength portion 28 is equalized with the length L2 between the front end portion 16Fi and the corner portion 26C of the spacer member 26. For this reason, the corner portion 26C of the spacer member 26 comes to contact and interfere with a neighborhood of the low strength portion 28 of the front side member 14, which promotes the front side member 14 to bend (fold) from the low strength portion 28.

That is to say, transmitting the lateral force intensively to the low strength portion 28 makes it possible to cause the front side member 14 to bend (fold), with higher accuracy, from the aimed position (robustness improvement). Moreover, the low strength portion 28 opens outwardly in the vehicle width direction and is in the form of the vertically long concaved bead (concaved groove), which promotes further the deformation in a direction that makes the adjacent open peripheries of the concaved bead approach each other. In other words, the bending (folding) of the front side member 14 is further promoted.

Thereby, during an intermediate stage of the collision, in the vehicle body front portion structure 10, the bending (folding) of the front side member 14 can absorb the collision energy. In addition, thus bent (folded) front side member 14 is brought into contact and interferes with the power unit 22.

Thereby, the load transmission route is formed which is routed through the barrier Br, the spacer member 26, the power unit 22 and the front side member 14. In detail, the power unit 22 is in receipt of the collision load from the barrier Br as the lateral force. This collision load is transmitted, via the power unit 22 and its support structure or the like, to opposite side to the collided side in the vehicle rearward direction and the vehicle width (transmitted to each vehicle portion as the front-rearward directional load Fx and the vehicle width directional load Fy (lateral force) shown in FIG. 3B). Thus, it is possible to prevent or suppress the generation of local excessive deformation of the collision end portion of the vehicle body which is involved in the short overlap collision.

Moreover, when the automotive vehicle A itself is moved to an opposite side of the collision side due to that the lateral force (inertia force) which is the vehicle width inward directional component of the load is inputted to the power unit 22 which is considered the mass concentration part of the automotive vehicle A, the input of the collision load to the extending portion 20 per se is eliminated or suppressed the resulting lateral force (promotion of passing by). Accordingly, it is possible to prevent or suppress effectively the generation of local excessive deformation of the collision end portion of the vehicle body.

Especially, in the vehicle body front portion structure 10, as described above, the lateral force is transmitted from the bumper reinforcement 18, via the spacer member 26, to the front side member 14 (power unit 22). Thereby, the projection amount of the spacer member 26 makes it possible to set a timing (stroke from the collision) for which the front side member is caused to bend (fold) (the lateral force is transmitted to the power unit 22).

In addition, as described above, in the vehicle body front portion structure 10, at the initial stage of the short overlap collision, the compression breakage of the outer side wall 16Wo of the crash box 16 is larger than that of the inner side wall 16Wi. For this reason, the bumper reinforcement 18 is brought into bending (folding) from its front end portion 16Fi of the inner side wall 16Wi. Thereby, the spacer member 26 is brought into contact with the front side member 14 with moving along a path that is in the form of snaking the flanges 14F and 16F. Consequently, it is possible for the spacer member 26 to interfere with the flanges 14F and 16F with little constraint. In other words, the vehicle body front portion structure has higher design flexibility in the structure provided with the spacer member 26 than the structure in which mainly the extending portion 20 is brought into deformation in the rearward direction after the compression breakage of the crash box 16.

(Summary)

As detailed above, compared to the structure in which both the bumper reinforcement 18 and the front side member 14 are provided with protrusions, respectively, the vehicle body front portion structure 10 is capable of improving the collision performance against a short overlap collision and an oblique collision, with the number of parts and the increase of mass suppressed.

[Modifications]

It is to be noted that though the aforementioned embodiment exemplifies the front side member 14 in which the low strength portion 28 is formed, the present invention is not limited thereto. For example, the front side member 14 may not be provided with the low strength portion 28.

In addition, though the aforementioned embodiment exemplifies the bumper reinforcement 18 which is provided with the spacer member 26, however the present invention is not limited thereto. For example, a configuration is available without having to include the spacer member 26 or providing the space member at the side of the front side member 14.

Further, though the aforementioned embodiment exemplifies the plural vertical beads 24, as easy to deform structures, are provided in the outer side wall 16Wo of the crash box 16, however the present invention is not limited thereto in light of the fact that the outer side wall 16Wo remains lower in strength against compression load than the inner side wall 16Wi. Consequently, for example, making the outer side wall 16Wo thinner than the inner side wall 16Wi is available or forming one or more openings or notches is also available.

Furthermore, though the aforementioned embodiment exemplifies that the low strength portion 28 of the front side member 14 is in the form of concaved beads, however the present invention is not limited thereto. For example, the low strength portion 28 may be formed by making a specific portion of the outer side wall 14Wo thinner than other portions or by omitting reinforcement at a specific portion.

In addition, though the aforementioned embodiment exemplifies that the bumper reinforcement 18 formed of a single member, however the present invention is not limited thereto. For example, the main portion of the extending portion 20 may be in the form of an extension member connected to the bumper reinforcement body.

Further, though the aforementioned embodiment exemplifies the vehicle body front portion structure 10 which is a right and left symmetrical structure with respect to a center line in the vehicle width direction, however the present invention is not limited thereto. For example, a structure embodying the present invention may be adapted at either one of opposite sides in the vehicle width direction.

Still further, though the aforementioned embodiment exemplifies the framing member 12 which is a combination of the front side member 14 and the crash box 16, however the present invention is not limited thereto. For example the framing member may configured, with the crash box 16 omitted, to include a front side member whose front end portion acts as an energy absorbing portion which is lower in compressive strength than other portions.

Other than the above, needless to say, it is possible to carry out the present invention by modifying the same as appropriate within the scope not departing from the gist of the present invention.

What is claimed is:

1. A vehicle body front portion structure, comprising
a front side member arranged such that lengthwise direction of the front side member is in coincidence with a vehicle front-rearward direction, the front side member being arranged to offset to a vehicle width directional one side;
a bumper reinforcement arranged such that lengthwise direction of bumper reinforcement in coincidence with the vehicle width direction, the bumper reinforcement being arranged in front of the front side member in the vehicle front-rearward direction such that an one side end portion of the bumper reinforcement in the vehicle width direction extends outwardly in the vehicle width direction relative to the front side member; and
an energy absorbing member interposed between a front end portion of the front side member and the bumper reinforcement, the energy absorbing member being configured such that a vehicle width directional outer side of the energy absorbing member is lower in strength against a load from a frontward direction of the vehicle than a vehicle width directional inner side of the energy absorbing member.

2. The vehicle body front portion structure according to claim 1, wherein
a low strength portion is formed at a specific portion of a wall portion of the front side member in the vehicle front-rearward direction that faces outwardly in the vehicle width direction, the low strength portion being set to be lower in strength against bending than other portions.

3. The vehicle body front portion structure according to claim 2, wherein
the low strength portion is in the form of a concave bead which opens toward outwardly in the vehicle width direction at the wall portion, the concave bead being arranged such that lengthwise direction of the concave bead is in coincidence with a vehicle vertical direction.

4. The vehicle body front portion structure according to claim 1, wherein
a portion of the bumper reinforcement which projects outwardly in the vehicle width direction from the front side member is formed with a projection which extends in a vehicle rearward direction.

5. The vehicle body front portion structure according to claim 4,
wherein a low strength portion which is set to be lower in strength against bending than other portions is formed at a specific portion of a wall portion of the front side member in the vehicle front-rearward direction that faces outwardly in the vehicle width direction, and wherein the low strength portion in the wall portion is formed at a position where a length between a front end portion of a vehicle width directional inside portion of the energy absorbing member and the low strength portion is equal to a length between the front end portion of a vehicle width directional inside portion of the energy absorbing member and the projection.
